(19) United States
(12) Patent Application Publication
(10) Pub. No.: US 2024/0349358 A1
(43) Pub. Date: Oct. 17, 2024

(54) METHOD FOR PROCESSING RANDOM ACCESS PROCEDURE, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 18/755,930

(22) Filed: Jun. 27, 2024

Related U.S. Application Data
(63) Continuation of application No. PCT/CN2021/141645, filed on Dec. 27, 2021.

(51) Int. Cl. H04W 74/0833; H04W 52/02

(52) U.S. Cl. CPC H04W 74/0833; H04W 52/0229; H04W 52/0235

(57) ABSTRACT

A method for processing a random access procedure, a terminal device, and a network device are provided. The method includes the following. A terminal device receives, in the random access procedure, an indication of entering a low-power receiver state sent by a network device. The terminal device determines, according to first information, to terminate the random access procedure and enter the low-power receiver state, or to continue the random access procedure.

### CROSS REFERENCE TO RELATED APPLICATION(S)

This application is a continuation of International Application No. PCT/CN2021/141645, filed Dec. 27, 2021, the entire disclosure of which is incorporated herein by reference.

### TECHNICAL FIELD

The disclosure relates to the field of communication technology, and in particular to a method for processing a random access procedure, a terminal device, and a network device.

### BACKGROUND

In a communication system, in order to ensure orthogonality between uplink transmissions to avoid intra-cell interference in uplink transmissions from different user equipments (UE) in the same cell, a wireless base station gNB requires that times when signals from different UEs at the same moment but with different frequency domain resources arrive at the gNB are substantially aligned. In order to ensure time synchronization at the gNB side, new radio (NR) supports a mechanism of uplink timing advance.

An uplink clock and a downlink clock at the gNB side are the same, while an offset exists between an uplink clock and a downlink clock at the UE side, and different UEs have different uplink timing advances. The gNB controls times when uplink signals from different UEs arrive at the gNB by controlling the offset of each UE. For example, a UE far away from the gNB sends uplink data earlier than a UE close to the gNB due to a larger transmission delay.

The gNB determines a timing advance (TA) value for each UE by measuring the uplink transmission of the UE. The gNB sends a timing advance command (TAC) to the UE in two ways. For acquisition of an initial TA value, in a random access procedure, the gNB determines the TA value by measuring a received preamble and sends the TA value to the UE via a TAC field of an RAR. For adjustment of a TA value in a radio resource control (RRC) connected state, although the UE achieves uplink synchronization with the gNB in the random access procedure, the timing at which the uplink signal arrives at the gNB may change over time.

Therefore, the UE needs to update its uplink TA continuously to maintain uplink synchronization. If a TA of a particular UE needs to be corrected, the gNB sends a TAC to the UE to request the UE to adjust its uplink timing. The TAC is sent to the UE via a TAC media access control (MAC) control element (CE).

For a UE in the connected state, a network enables the UE to maintain a valid TA via a time alignment timer (TimeAlignmentTimer), i.e., the TA maintained by the UE is valid during running of the time alignment timer. The UE restarts the time alignment timer each time the network updates the TA. After the time alignment timer times out, the UE needs to trigger random access to reacquire the TA if the UE has uplink data to send.

However, when executing the random access procedure, if the terminal receives an indication of entering a low-power receiver state from a base station, the terminal enters the low-power receiver state and turns off a main receiver. As a result, it will be difficult to maintain the TA. Therefore, how to process the random access procedure if the terminal receives, in the random access procedure, the indication of entering the low-power receiver state from the base station becomes a problem to be solved.

### SUMMARY

In a first aspect, a method for processing a random access procedure includes the following. A terminal device receives, in the random access procedure, an indication of entering a low-power receiver state sent by a network device. The terminal device determines, according to first information, to terminate the random access procedure and enter the low-power receiver state, or to continue the random access procedure.

In a second aspect, a terminal device includes a transceiver, a memory configured to store computer programs, and a processor configured to execute the computer programs stored in the memory to: cause the transceiver to receive, in a random access procedure, an indication of entering a low-power receiver state sent by a network device, and determine, according to first information, to terminate the random access procedure and enter the low-power receiver state, or to continue the random access procedure.

In a third aspect, a network device includes a transceiver, a memory configured to store computer programs, and a processor configured to execute the computer programs stored in the memory to: cause the transceiver to send, in a random access procedure, an indication of entering a low-power receiver state to a terminal device, and configure first information for the terminal device, to enable the terminal device to determine, according to the first information, to terminate the random access procedure and enter the low-power receiver state, or to continue the random access procedure.

### BRIEF DESCRIPTION OF THE DRAWINGS

FIG. 1 is a diagram illustrating an architecture of a system applied in embodiments of the disclosure.

FIG. 2 is a schematic flowchart of a method for processing a random access procedure provided in embodiment 1 of the disclosure.

FIG. 3 is a more specific schematic flowchart of an operation at S220 in embodiment 1 of the disclosure.

FIG. 4 is a schematic diagram illustrating modules of a terminal device provided in embodiment 2 of the disclosure.

FIG. 5 is a schematic diagram illustrating modules of a network device provided in embodiment 3 of the disclosure.

FIG. 6 is a schematic flowchart of a method for random access provided in embodiment 4 of the disclosure.

FIG. 7 is a schematic diagram illustrating modules of a terminal device provided in embodiment 5 of the disclosure.

FIG. 8 is a schematic structural diagram of an apparatus for a random access procedure provided in embodiment 6 of the disclosure.

### DETAILED DESCRIPTION

In order to make the objectives, technical solutions, and advantages of the disclosure clearer, the disclosure will be further described in detail below with reference to the accompanying drawings and embodiments. It is understood that embodiments illustrated herein are merely intended for illustration and do not constitute limitation on the disclosure. However, the disclosure can be implemented in different forms and is not limited to the embodiments described herein. On the contrary, these embodiments are provided for the purpose of providing more thorough and comprehensive understanding of the utility model disclosure.

Unless otherwise defined, all technical and scientific terms used herein have the same meaning as commonly understood by those skilled in the art of the present disclosure. The terms used herein in the disclosure are for the purpose of describing embodiments only and are not intended to limit the disclosure.

It can be understood that, the terms “system” and “network” in this disclosure are often used interchangeably. The term “and/or” in this disclosure is simply an illustration of an association relationship of associated objects, indicating that three relationships may exist, for example, A and/or B, which may indicate the existence of A alone, A and B together, and B alone. In addition, the character “/” in this disclosure generally indicates that associated objects are in an “or” relationship.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), a next-generation communication system, or other communication systems, etc.

Generally speaking, a conventional communication system generally supports a limited quantity of connections and therefore is easy to implement. However, with development of communication technology, a mobile communication system will not only support conventional communication but also support, for example, device-to-device (D2D) communication, machine-to-machine (M2M) communication, machine-type communication (MTC), or vehicle-to-vehicle (V2V) communication, etc. Embodiments of the disclosure can also be applied to these communication systems.

Optionally, the communication system in embodiments of the disclosure may be applied to a carrier aggregation (CA) scenario, or may be applied to a dual connectivity (DC) scenario, or may be applied to a standalone (SA) scenario.

There is no limitation on the type of spectrum in embodiments of the disclosure. For example, embodiments of the disclosure are applicable to a licensed spectrum, and also applicable to an unlicensed spectrum.

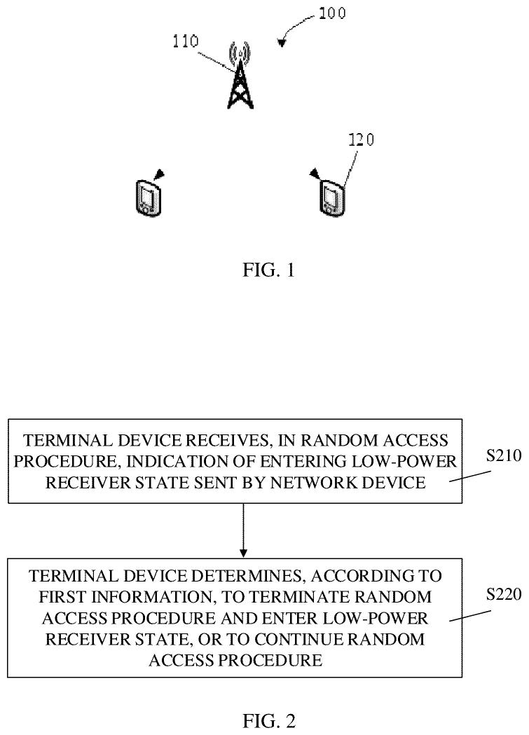

Reference is made to FIG. 1. FIG. 1 illustrates a wireless communication system 100 applied in embodiments of the disclosure. The wireless communication system 100 includes a network device 110 and at least one user equipment (UE) 120 in the coverage area of the network device 110. The network device 110 sends a triggering signaling or downlink control information (DCI) to the UE 120, and the UE 120 sends ACK/NACK feedback information to the network device according to the triggering signaling or the DCI.

Optionally, the wireless communication system 100 may include multiple network devices, and there can be other quantities of UEs in a coverage area of each of the network devices. Embodiments of the disclosure are not limited in this regard.

The network device 110 can provide communication coverage for a particular geographic region and communicate with terminal devices (for example, UEs) within the coverage area. Optionally, the network device 110 may be a base transceiver station (BTS) in a GSM system or a CDMA system, or may be a NodeB (NB) in a WCDMA system, or may be an evolutional Node B (eNB or eNodeB) in an LTE system, or a radio controller in a cloud radio access network (CRAN). Alternatively, the network device may be a relay station, an access point, an in-vehicle device, a wearable device, a network-side device in a 5G network, or a network device in a future evolved public land mobile network (PLMN), etc.

The terminal device 120 may be mobile or fixed. Optionally, the UE 120 may refer to an access terminal, a UE, a user unit, a user station, a mobile station, a remote station, a remote terminal, a mobile device, a user device, a terminal, a wireless communication device, a user agent, or a user apparatus. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a UE in the 5G network, or a UE in the future evolved PLMN, etc.

The following embodiments of the disclosure will describe in detail a method for processing a random access procedure if a terminal device receives an indication of entering a low-power receiver state from a base station during the random access procedure, a method for processing after a terminal device exits the low-power state, a terminal device, and a network device thereof.

### Embodiment 1

Reference is made to FIG. 2. FIG. 2 illustrates a method for processing a random access procedure provided in embodiment 1 of the disclosure. The method includes the following.

At S210, a terminal device receives, in the random access procedure, an indication of entering a low-power receiver state sent by a network device.

At S220, the terminal device determines, according to first information, to terminate the random access procedure and enter the low-power receiver state, or to continue the random access procedure.

Optionally, the random access procedure includes a first type of random access procedure and a second type of random access procedure, and the first information indicates at least one of the first type of random access procedure or the second type of random access procedure, where the first type of random access procedure is a random access procedure to be terminated after the terminal device receives the indication of entering the low-power receiver state, and the second type of random access procedure is a random access procedure to be continued after the terminal device receives the indication of entering the low-power receiver state. Optionally, the first information may be configured by the network device via a radio resource control (RRC) dedicated signaling or a system message.

Optionally, the first type of random access procedure is a random access procedure without service transmission, for example, a random access procedure triggered based on the following events: beam failure recovery (BFR), request for other SI, or to establish time alignment for a secondary timing advance group (TAG), etc.

Optionally, the second type of random access procedure is a random access procedure with service transmission, for example, a random access procedure triggered based on the following events: SR failure, or request by RRC upon synchronous reconfiguration (e.g. handover), etc.

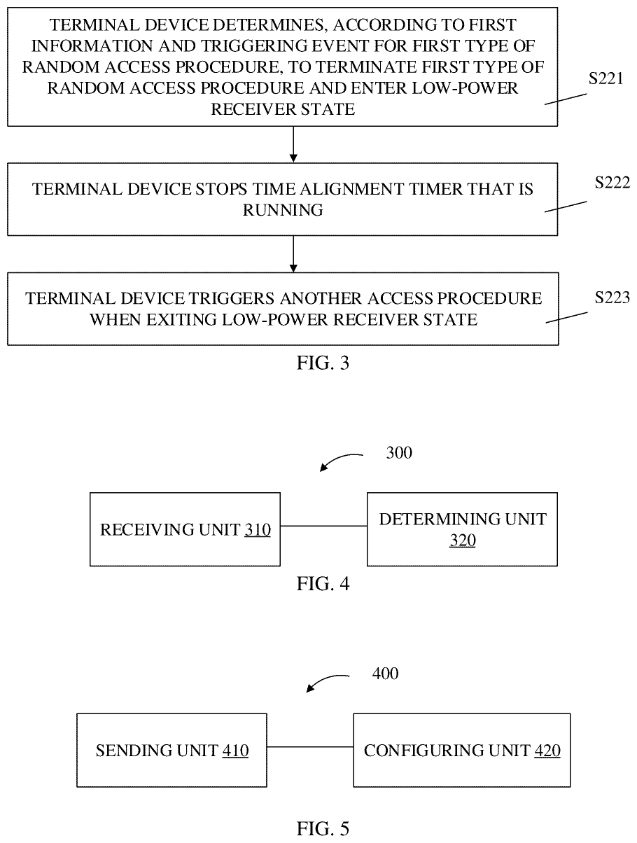

Optionally, as illustrated in FIG. 3, in a case where the random access procedure is the first type of random access procedure, at S220, the terminal device determines, according to the first information, to terminate the random access procedure and enter the low-power receiver state, or to continue the random access procedure as follows.

At S221, the terminal device determines, according to the first information and a triggering event for the first type of random access procedure, to terminate the first type of random access procedure and enter the low-power receiver state.

In the above embodiment, the random access procedure is classified into two types according to whether the random access procedure has service transmission. For the random access without service transmission, for example, a random access procedure triggered by BFR, for the sake of energy saving, the terminal device may enter the low-power receiver state and stop beam management after receiving an indication of entering the low-power receiver state. For the random access with service transmission, for example, random access triggered by SR failure, the terminal device may ignore an indication of entering the low-power receiver state sent by a base station and continue to request uplink resources. In this way, service transmission can be facilitated and user experience can be improved.

Optionally, reference is still made to FIG. 3. In a case where the random access procedure is the first type of random access procedure, at S220, the terminal device determines, according to the first information, to terminate the random access procedure and enter the low-power receiver state, or to continue the random access procedure further as follows.

At S222, the terminal device stops a time alignment timer that is running.

The operation at S222 specifically includes the following.

After receiving a TA adjustment sent by the network device (e.g., a base station), the terminal device in a connected state starts or restarts a time alignment timer (TimeAlignmentTimer) corresponding to a TAG.

After receiving an indication of entering the low-power receiver state sent by the base station during running of the time alignment timer, the terminal stops the time alignment timer that is running.

In the low-power receiver state, the terminal device turns off a main receiver, the terminal device may not be able to perform operations such as RRM measurement and synchronization, and the network device may not be able to adjust a TA of the UE in time. Therefore, the terminal device cannot consider that uplink transmission in the low-power receiver state is still maintained in a synchronized state. At S222, the time alignment timer that is running is stopped, which can effectively prevent the terminal device from considering that the TA is still valid when the main receiver is started subsequently and from using the TA for uplink transmission.

Optionally, in a case where the random access procedure is the first type of random access procedure, at S220, the terminal device determines, according to the first information, to terminate the random access procedure and enter the low-power receiver state, or to continue the random access procedure further as follows.

At S223, the terminal device triggers another random access procedure when exiting the low-power receiver state. The terminal device triggers another random access procedure when exiting the low-power receiver state, so as to obtain an uplink TA as soon as possible for subsequent uplink data transmission and/or uplink feedback of downlink data.

Optionally, reference is still made to FIG. 3. At S223, the terminal device triggers the another random access procedure when exiting the low-power receiver state as follows.

The terminal device in a connected state monitors, in the low-power receiver state, a low-power wake-up service (WUS) signal. The terminal device performs at least one of: turning on a main receiver, stabilizing a crystal oscillator, performing downlink synchronization for a service cell, or triggering a random access procedure, when the low-power WUS signal is received and indicates wakening up the terminal device. A resource for the another random access procedure is determined.

Optionally, the resource for the another random access procedure includes at least one initial bandwidth part BWP among: an initial BWP, a last active BWP used by the terminal device before entering the low-power receiver state, or a default BWP.

Optionally, the resource for the another random access procedure is a common random access channel (RACH) resource or a dedicated RACH resource on the at least one BWP.

Optionally, the dedicated RACH resource includes a dedicated RACH occasion (RO) resource and/or a dedicated preamble.

In embodiment 1 of the disclosure, the terminal device determines, according to the first information, whether to terminate the random access procedure and enter the low-power receiver state, or to continue to perform the random access procedure. The random access procedure can be classified. In a specific random access procedure, the terminal device terminates an ongoing random access procedure and enters the low-power receiver state when receiving the indication of entering the low-power receiver state. For other random access procedures, the terminal device ignores the indication of entering the low-power receiver state sent by the network device and continues to perform the random access procedure. In this way, service transmission can be facilitated and user experience can be improved.

### Embodiment 2

Reference is made to FIG. 4. FIG. 4 illustrates a terminal device 300 provided in embodiment 2 of the disclosure. The terminal device 300 includes a receiving unit 310 and a determining unit 320. The receiving unit 310 is configured to receive, in a random access procedure, an indication of entering a low-power receiver state sent by a network device. The determining unit 320 is configured to determine, according to first information, to terminate the random access procedure and enter the low-power receiver state, or to continue the random access procedure.

Optionally, the random access procedure includes a first type of random access procedure and a second type of random access procedure, and the first information indicates at least one of the first type of random access procedure or the second type of random access procedure, where the first type of random access procedure is a random access procedure to be terminated after the terminal device receives the indication of entering the low-power receiver state, and the second type of random access procedure is a random access procedure to be continued after the terminal device receives the indication of entering the low-power receiver state.

Optionally, the first type of random access procedure is a random access procedure without service transmission.

Optionally, the second type of random access procedure is a random access procedure with service transmission.

Optionally, in a case where the random access procedure is the first type of random access procedure, the determining unit is specifically configured to determine, according to the first information and a triggering event for the first type of random access procedure, to terminate the first type of random access procedure and enter the low-power receiver state.

Optionally, in a case where the random access procedure is the first type of random access procedure, the determining unit 320 is further configured to stop a time alignment timer that is running.

Optionally, in a case where the random access procedure is the first type of random access procedure, the determining unit 320 is further configured to trigger another random access procedure when exiting the low-power receiver state.

Optionally, the determining unit 320 is specifically configured to monitor, in the low-power receiver state, a low-power WUS signal, perform at least one of: turning on a main receiver, stabilizing a crystal oscillator, performing downlink synchronization for a service cell, or triggering a random access procedure, when the low-power WUS signal is received and indicates wakening up the terminal device, and determine a resource for the another random access procedure.

Optionally, the resource for the another random access procedure includes at least one BWP among: an initial BWP, a last active BWP used by the terminal device before entering the low-power receiver state, or a default BWP.

Optionally, the resource for the another random access procedure is a common RACH resource or a dedicated RACH resource on the at least one BWP.

Optionally, the dedicated RACH resource includes a dedicated RO resource and/or a dedicated preamble.

Some detailed illustrations are omitted in embodiment 2, and reference can be made to the same or corresponding illustrations in embodiment 1, which are not repeated herein.

### Embodiment 3

Reference is made to FIG. 5. FIG. 5 illustrates a network device 400 provided in embodiment 3 of the disclosure. The network device 400 includes a sending unit 410 and a configuring unit 420. The sending unit 410 is configured to send, in a random access procedure, an indication of entering a low-power receiver state to a terminal device. The configuring unit 420 is configured to configure first information for the terminal device, to enable the terminal device to determine, according to the first information, to terminate the random access procedure and enter the low-power receiver state, or to continue the random access procedure.

Optionally, the random access procedure includes a first type of random access procedure and a second type of random access procedure, and the first information indicates at least one of the first type of random access procedure or the second type of random access procedure, where the first type of random access procedure is a random access procedure to be terminated after the terminal device receives the indication of entering the low-power receiver state, and the second type of random access procedure is a random access procedure to be continued after the terminal device receives the indication of entering the low-power receiver state.

Optionally, the first type of random access procedure is a random access procedure without service transmission.

Optionally, the second type of random access procedure is a random access procedure with service transmission.

Some detailed illustrations are omitted in embodiment 3, and reference can be made to the same or corresponding illustrations in embodiment 1 or embodiment 2, which are not repeated herein.

### Embodiment 4

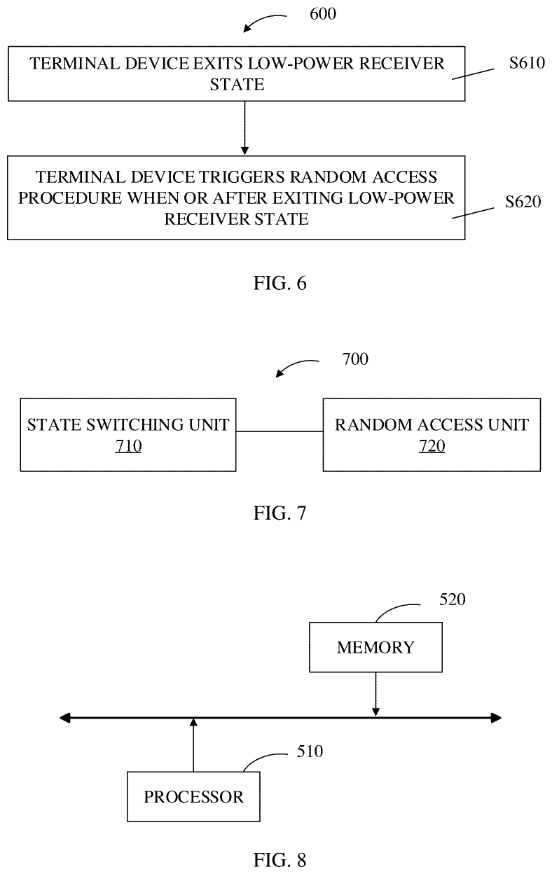

The operation at S223 in embodiment 1 is a method 600 (i.e., embodiment 4) which can be performed independently. Reference is made to FIG. 6. FIG. 6 illustrates a method for random access provided in embodiment 4 of the disclosure. The method includes the following.

At S610, a terminal device exits a low-power receiver state.

At S620, the terminal device triggers a random access procedure when or after exiting the low-power receiver state.

Optionally, at S620, the terminal device triggers the random access procedure when or after exiting the low-power receiver state as follows.

The terminal device in a connected state monitors, in the low-power receiver state, a low-power WUS signal. The terminal device performs at least one of: turning on a main receiver, stabilizing a crystal oscillator, performing downlink synchronization for a service cell, or triggering a random access procedure, when the low-power WUS signal is received and indicates wakening up the terminal device. The terminal device determines a resource for the random access procedure.

Optionally, the resource for the random access procedure comprises at least one BWP among: an initial BWP, a last active BWP used by the terminal device before entering the low-power receiver state, or a default BWP.

Optionally, the resource for the random access procedure is a common RACH resource or a dedicated RACH resource on the at least one BWP.

Optionally, the dedicated RACH resource includes a dedicated RO resource and/or a dedicated preamble.

Some detailed illustrations are omitted in embodiment 4, and reference can be made to the same or corresponding illustrations in embodiment 1, for example, illustrations for the operation at S223, which are not repeated herein.

### Embodiment 5

Reference is made to FIG. 7. FIG. 7 illustrates a terminal device 700 provided in embodiment 5 of the disclosure. The terminal device includes a state switching unit 710 and a random access unit 720. The state switching unit 710 is configured to exit a low-power receiver state. The random access unit 720 is configured to trigger a random access procedure when or after exiting the low-power receiver state.

Optionally, the random access unit 720 is specifically configured to monitor, in the low-power receiver state, a low-power WUS signal, perform at least one of: turning on a main receiver, stabilizing a crystal oscillator, performing downlink synchronization for a service cell, or triggering a random access procedure, when the low-power WUS signal is received and indicates wakening up the terminal device, and determine a resource for the random access procedure.

Optionally, the resource for the random access procedure includes at least one BWP among: an initial BWP, a last active BWP used by the terminal device before entering the low-power receiver state, or a default BWP.

Optionally, the resource for the random access procedure is a common RACH resource or a dedicated RACH resource on the at least one BWP.

Optionally, the dedicated RACH resource includes a dedicated RO resource and/or a dedicated preamble.

The terminal device 700 provided in embodiment 5 corresponds to the method 600 provided in embodiment 4 and is the same as or corresponds to part of the functions performed by the determining unit 320 in embodiment 2. As a result, some detailed illustrations are omitted in embodiment 5, and reference can be made to the same or corresponding illustrations in embodiment 1, embodiment 2, or embodiment 3, which are not repeated herein.

### Embodiment 6

Reference is made to FIG. 8. FIG. 8 illustrates a schematic structural diagram of a terminal device 500 provided in embodiment 6 of the disclosure. The terminal device 500 includes a processor 510 and a memory 520. The processor 510 and the memory 520 are in a communication connection with each other via a bus system.

The memory 520 is a computer-readable storage medium and stores programs executable by the processor 510. The processor 510 is configured to invoke programs stored in the memory 520 to perform corresponding operations implemented by the terminal device in the method for processing a random access procedure provided in embodiment 1, or to perform corresponding operations implemented by the network device in the method for processing a random access procedure provided in embodiment 1, or to perform corresponding operations in the method for random access provided in embodiment 4.

The processor 510 may be a separate component or may be a collective term for multiple processing components. For example, the processor 510 may be a central processing unit (CPU), or may be an application specific integrated circuit (ASIC), or may be one or more integrated circuits configured to implement the foregoing method such as at least one microprocessor (e.g. digital signal processor (DSP)) or at least one field programmable gate array (FPGA), etc.

Those skilled in the art will appreciate that, all or part of functions described in implementations of the disclosure can be implemented through software, hardware, firmware, or any other combination thereof. When implemented by software, all or part of the functions can be implemented by executing software instructions by a processor. The software instructions can be implemented by corresponding software modules, which can be stored in a computer-readable storage medium. The computer-readable storage medium can be any computer accessible usable medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc. The computer-readable storage medium includes, but is not limited to, a random access memory (RAM), a flash memory, a read-only memory (ROM), an erasable programmable ROM (EPROM), an electrically EPROM (EEPROM), registers, hard disk, mobile hard disk, compact disc (CD)-ROM, or any other form of storage medium known in the art. An exemplary computer-readable storage medium is coupled to the processor, such that the processor can read information from the computer-readable storage medium and write information to the computer-readable storage medium. The computer-readable storage medium can also be a component of the processor. The processor and the computer-readable storage medium may be located in an ASIC. In addition, the ASIC can be located in an access-network device, a target network device, or a core-network device. The processor and the computer-readable storage medium may also be present as discrete components in the access-network device, the target network device, or the core-network device. When implemented by software, all or part of the functions can be implemented in the form of a computer program product. The computer program product includes one or more computer instructions. When the computer instructions are applied and executed on a computer, all or part of the operations or functions of the implementations of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc.

The foregoing embodiments illustrate but do not constitute limitation on the disclosure. Those skilled in the art can devise multiple substitutable embodiments within the scope of the claims. Those skilled in the art will appreciate that the disclosure is not limited to the specific structures already described above and illustrated in the accompanying drawings, and that appropriate adjustments, modifications, equivalent substitutions, improvements, and the like may be made to the specific embodiments within the scope of the disclosure defined in the claims. Therefore, any modification and variation made within the spirit and principles of the disclosure shall be included in the scope of the disclosure defined in the claims.

What is claimed is:

1. A method for processing a random access procedure, comprising:
receiving, by a terminal device, in the random access procedure, an indication of entering a low-power receiver state sent by a network device; and
determining, by the terminal device, according to first information, to terminate the random access procedure and enter the low-power receiver state, or to continue the random access procedure.

2. The method of claim 1, wherein the random access procedure comprises a first type of random access procedure and a second type of random access procedure, and the first information indicates at least one of the first type of random access procedure or the second type of random access procedure; and
the first type of random access procedure is a random access procedure to be terminated after the terminal device receives the indication of entering the low-power receiver state, and the second type of random access procedure is a random access procedure to be continued after the terminal device receives the indication of entering the low-power receiver state.

3. The method of claim 2, wherein the first type of random access procedure is a random access procedure without service transmission.

4. The method of claim 2, wherein the second type of random access procedure is a random access procedure with service transmission.

5. The method of claim 2, wherein in a case where the random access procedure is the first type of random access procedure, determining, by the terminal device, according to the first information, to terminate the random access procedure and enter the low-power receiver state, or to continue the random access procedure comprises:
determining, by the terminal device, according to the first information and a triggering event for the first type of random access procedure, to terminate the first type of random access procedure and enter the low-power receiver state.

6. The method of claim 5, wherein in a case where the random access procedure is the first type of random access procedure, determining, by the terminal device, according to the first information, to terminate the random access procedure and enter the low-power receiver state, or to continue the random access procedure further comprises:
stopping, by the terminal device, a time alignment timer that is running.

7. The method of claim 5, wherein in a case where the random access procedure is the first type of random access procedure, determining, by the terminal device, according to the first information, to terminate the random access procedure and enter the low-power receiver state, or to continue the random access procedure further comprises:
triggering, by the terminal device, another random access procedure when or after exiting the low-power receiver state.

8. The method of claim 7, wherein triggering, by the terminal device, the another random access procedure when exiting the low-power receiver state comprises:
monitoring, by the terminal device in a connected state, in the low-power receiver state, a low-power wake-up service (WUS) signal;
performing, by the terminal device, at least one of: turning on a main receiver, stabilizing a crystal oscillator, performing downlink synchronization for a service cell, or triggering a random access procedure, when the low-power WUS signal is received and indicates wakening up the terminal device; and
determining a resource for the another random access procedure.

9. A terminal device, comprising:
a transceiver;
a memory configured to store computer programs; and
a processor configured to execute the computer programs stored in the memory to:
cause the transceiver to receive, in a random access procedure, an indication of entering a low-power receiver state sent by a network device; and
determine, according to first information, to terminate the random access procedure and enter the low-power receiver state, or to continue the random access procedure.

10. The terminal device of claim 9, wherein the random access procedure comprises a first type of random access procedure and a second type of random access procedure, and the first information indicates at least one of the first type of random access procedure or the second type of random access procedure; and
the first type of random access procedure is a random access procedure to be terminated after the terminal device receives the indication of entering the low-power receiver state, and the second type of random access procedure is a random access procedure to be continued after the terminal device receives the indication of entering the low-power receiver state.

11. The terminal device of claim 10, wherein the first type of random access procedure is a random access procedure without service transmission.

12. The terminal device of claim 10, wherein the second type of random access procedure is a random access procedure with service transmission.

13. The terminal device of claim 10, wherein in a case where the random access procedure is the first type of random access procedure, the processor is specifically configured to determine, according to the first information and a triggering event for the first type of random access procedure, to terminate the first type of random access procedure and enter the low-power receiver state.

14. The terminal device of claim 13, wherein in a case where the random access procedure is the first type of random access procedure, the processor is further configured to stop a time alignment timer that is running.

15. The terminal device of claim 13, wherein in a case where the random access procedure is the first type of random access procedure, the processor is further configured to trigger another random access procedure when or after exiting the low-power receiver state.

16. The terminal device of claim 15, wherein the processor is specifically configured to:
monitor, in the low-power receiver state, a low-power wake-up service (WUS) signal;
perform at least one of: turning on a main receiver, stabilizing a crystal oscillator, performing downlink synchronization for a service cell, or triggering a random access procedure, when the low-power WUS signal is received and indicates wakening up the terminal device; and
determine a resource for the another random access procedure.

17. A network device, comprising:
a transceiver;
a memory configured to store computer programs; and
a processor configured to execute the computer programs stored in the memory to:
cause the transceiver to send, in a random access procedure, an indication of entering a low-power receiver state to a terminal device; and
configure first information for the terminal device, to enable the terminal device to determine, according to the first information, to terminate the random access procedure and enter the low-power receiver state, or to continue the random access procedure.

18. The network device of claim 17, wherein the random access procedure comprises a first type of random access procedure and a second type of random access procedure, and the first information indicates at least one of the first type of random access procedure or the second type of random access procedure; and
the first type of random access procedure is a random access procedure to be terminated after the terminal device receives the indication of entering the low-power receiver state, and the second type of random access procedure is a random access procedure to be continued after the terminal device receives the indication of entering the low-power receiver state.

19. The network device of claim 18, wherein the first type of random access procedure is a random access procedure without service transmission.

20. The network device of claim 18, wherein the second type of random access procedure is a random access procedure with service transmission.
